(19) United States
(12) Patent Application Publication
(10) Pub. No.: US 2026/0112864 A1
(43) Pub. Date: Apr. 23, 2026

(54) Distribution device, outlet box, distribution assembly, electrical panel and associated locating method

(71) Applicant: Schneider Electric Industries SAS, Rueil Malmaison (FR)

(72) Inventors: Eric DOMEJEAN, Voreppe (FR); Guillaume Tanguy, Meylan (FR); Calude Burnot, Echirolles (FR); Fabien Corona, Uchizy (FR)

(21) Appl. No.: 19/359,189

(22) Filed: Oct. 15, 2025

(30) Foreign Application Priority Data
Oct. 21, 2024 (FR) FR2411463

(51) Int. Cl. H02B 1/20

(52) U.S. Cl. CPC H02B 1/20

(57) ABSTRACT

Distribution device, and associated outlet module, distribution assembly, electrical panel and location method This electrical power distribution device, which is configured to distribute electrical energy from a power source to at least one electrical load, comprises a power bus, through which electrical energy is transferred and which is configured to accommodate at least two outlet modules, which are each intended to be connected to the power bus and to a respective electrical load. The distribution device comprises a transfer bus (150), which defines a plurality of mounting zones (154) for each outlet module, with each mounting zone being associated with a unique position along a main axis (A110). The transfer bus comprises, for each mounting zone, an identification circuit (160), which is configured to send each outlet module information relating to the position of the mounting zone where this outlet module is mounted.

### BACKGROUND

The present invention relates to an electrical power distribution device, an outlet module configured to be connected to such a distribution device, a distribution assembly comprising such a distribution device, as well as an electrical panel comprising such a distribution assembly. The invention also relates to a location method.

An electrical power distribution assembly is used to supply electrical energy to one or more electrical loads, with the electrical energy being supplied by a power source. The focus in this case is on modular distribution assemblies, i.e., assemblies that can be configured as required, notably according to the number or nature, notably single-phase or multi-phase, of the electrical loads. The distribution assembly thus comprises a distribution device including a power bus, on which one or more outlet modules can be reversibly mounted. Each outlet module is then connected to a respective electrical load.

The distribution device comprises a transfer bus, which allows information to be transferred to the outlet modules and/or electrical energy to be transferred that is required for the operation of the outlet modules. For operational and/or maintenance purposes, the position where the outlet modules are mounted on the distribution device needs to be known. For example, the outlet modules include differential current sensors and are remotely configurable.

It is known for communication protocols to be used that allow dynamic addressing when mounting the outlet modules. However, these protocols require the use of relatively complex and long messages in terms of bits, which means that the outlet modules must be equipped with dedicated communication modules, which are bulky and energy consuming. Furthermore, in the case of sensitive applications related to personal safety, the use of such protocols is difficult to implement securely.

It is these problems that the invention more specifically aims to overcome by proposing a distribution device that is both simple and reliable, while allowing the position of the outlet modules to be identified when they are mounted on the distribution device.

### SUMMARY

To this end, the invention relates to an electrical power distribution device configured to distribute electrical energy from a power source to at least one electrical load, the power source comprising a neutral and at least one phase, the distribution device comprising:
a power bus which comprises a plurality of busbars:
   which include a neutral bar and at least one phase bar and optionally a neutral bar, with the neutral bar being associated with the neutral of the power source, each phase bar being respectively associated with a phase of the power source;
   which extend parallel to each other along a main axis of the distribution device and which are aligned along a height axis that is orthogonal to the main axis;
wherein:
the power bus is configured to accommodate at least two outlet modules, with each outlet module comprising:
   an inlet terminal block, which can be reversibly connected to the busbars and which comprises inlet terminals, with each inlet terminal being configured to be electrically connected to a respective busbar; and
   an outlet terminal block, which is configured to be connected to an electrical load and which comprises outlet terminals, with each outlet terminal being respectively associated with a respective inlet terminal;
the distribution device also comprises a transfer bus, which comprises:
   a body, which is made of an electrically insulating material, which assumes an elongated shape extending along the power bus, and which defines a plurality of mounting zones for each outlet module, with the mounting zones being distributed along the main axis and each being associated with a unique position along the main axis;
   at least two transfer lines, which extend along the body and which are configured to be electrically connected to each outlet module when the outlet module is connected to the power bus in the vicinity of one of the mounting zones, with the outlet module being in a mounted position on the distribution device;
the transfer bus comprises a position identification circuit, which is configured to send the outlet module in the mounted configuration information relating to the position, along the main axis, of the mounting zone on which the outlet module is mounted.

By virtue of the invention, when an outlet module is mounted on the distribution device, this outlet module is able to immediately and unambiguously determine its position along the distribution device by means of an identification circuit that is simple to produce and is reliable. This avoids the use of more complicated protocols requiring bulky and/or energy-consuming components.

According to advantageous but non-compulsory aspects of the invention, such a distribution device can incorporate one or more of the following features, taken individually or according to any technically permissible combination:
for each mounting zone, the identification circuit comprises an identification component, which is selected from among a resistor, an inductor, a Zener diode, a voltage reference or a capacitor, such that when the outlet module is in the mounted configuration and is supplied with electrical energy, the outlet module applies a first electrical quantity across the terminals of the identification component and measures a second electrical quantity characteristic of the identification component, with the second characteristic electrical quantity being unambiguously linked to the unique position of the considered mounting zone;
for each mounting zone, the identification component is a resistor;
the resistors each have their own resistance value, which is expressed in ohms and which gradually changes when moving along the main axis;
the mounting zones are evenly distributed along the main axis;
the transfer bus comprises a plurality of mounting zones, for example, fifteen mounting zones, which are spaced apart from each other at regular intervals, for example, multiples of 9 mm.

The invention also relates to an outlet module, which is configured to be jointly connected to a distribution device as defined above, the outlet module comprising:
an inlet terminal block, which can be reversibly connected to the power bus and which comprises inlet terminals, with each inlet terminal being configured to be electrically connected to a respective busbar; and
an outlet terminal block, which is configured to be connected to an electrical load and which comprises outlet terminals, with each outlet terminal being associated with a respective inlet terminal; and
a transfer terminal block, which comprises:
   transfer terminals, which are configured to be connected to the transfer bus so as to be electrically connected to the transfer lines; and
   positioning terminals, which are configured to be electrically connected to the identification circuit associated with the considered mounting zone.

Advantageously, the outlet module also comprises a microcontroller, which is configured so that, when the outlet module is in the configuration whereby it is mounted on one of the mounting zones and is supplied with electrical energy, the outlet module applies, by means of the microcontroller, a first electrical quantity across the terminals of the identification component and measures a second electrical quantity characteristic of the identification component, with the second characteristic electrical quantity being unambiguously linked to the unique position of the considered mounting zone.

The invention also relates to a distribution assembly, comprising:
the distribution device as defined above; and
a copy of the outlet module as defined above; AND/OR
a main module, which is configured to be mounted on the distribution device and which comprises:
   input terminals, with each input terminal being configured to be connected to a respective phase and optionally to the neutral of the power source;
   output terminals, which are configured to be connected to the busbars, with each output terminal being associated with a respective busbar and a respective input terminal;
wherein:
the transfer bus also comprises a connection zone, which is intended to be connected to an additional terminal block of the main module in the mounted position, so that the main module is electrically connected to the transfer lines;
the main module is configured to receive, via the transfer lines and for each outlet module in the mounted position, information relating to the position, along the main axis, of the mounting zone on which the considered outlet module is mounted;
the outlet module and/or the main module are each in a configuration whereby they are mounted on the distribution device.

The invention also relates to an electrical panel, comprising:
a box, delimiting an enclosure and having a base;
the distribution assembly as defined above;
wherein the distribution assembly is fixed to the base of the box.

According to another aspect, the invention relates to a method for locating an outlet module mounted on a distribution device, the location method comprising:
providing the distribution device and an outlet module as defined above;
mounting the outlet module on one of the mounting zones, such that:
   the transfer terminal block is electrically connected to the transfer bus, supplying electrical energy to a microcontroller of the outlet module;
   the transfer terminal block is electrically connected to the identification circuit;
then, using the powered microcontroller:
   applying a first electrical quantity across the terminals of the identification component via the transfer terminal block, and measuring a second electrical quantity characteristic of the identification component; then
   deducing the unique position, along the transfer bus, of the mounting zone on which the outlet module is mounted, using a correspondence table previously stored in a memory of the microcontroller, unambiguously linking intervals of the second characteristic electrical quantity to a unique position along the transfer bus.

This method offers the same advantages as those mentioned above with respect to the distribution device of the invention.

### BRIEF DESCRIPTION OF DRAWINGS

The invention will be better understood, and further advantages thereof will become more clearly apparent, in light of the following description of an embodiment of a distribution device, an outlet module, a distribution sub-assembly, an electrical panel and a location method, in accordance with its principle, which is provided solely by way of an example and with reference to the accompanying drawings, in which:
FIG. 1 is a partially exploded perspective view of an electrical panel according to the invention, the electrical panel comprising a distribution assembly, also according to the invention;
FIG. 2 is a partially exploded perspective view of the distribution assembly of FIG. 1;
FIG. 3 FIGS. 3a and 3b show, in two inserts a) and b), respectively, a perspective view of the distribution assembly of FIG. 1, with some parts hidden, and a perspective view of a transfer bus of the distribution assembly;
FIG. 4 is a partially exploded perspective view of the distribution assembly of FIG. 1, with some parts hidden;
FIG. 5 is a schematic representation of the distribution assembly of FIG. 1; and
FIG. 6 FIGS. 6a and 6b show, in two inserts a) and b), respectively, a portion of the transfer bus of FIG. 3, viewed in perspective from two opposite angles.

### DETAILED DESCRIPTION

An electrical panel 10, according to the invention, is shown in FIG. 1. The electrical panel 10 comprises a box 12, which delimits an enclosure V12 and has a base 14. The base 14 is generally in a plane orthogonal to a depth axis A14. The enclosure V12 is advantageously closed by a door, which is not shown.

The electrical panel 10 comprises a distribution assembly 100. The distribution assembly 100 is fixed to the base 14 of the box 12. The distribution assembly 100 is configured to distribute electrical energy from a power source to at least one electrical load. In the illustrated example, the power source is a three-phase source, comprising a neutral and three phases. In a variant, not illustrated, the power source is single-phase, comprising a neutral and a single phase. According to another variant, the power source comprises three phases and no neutral.

The power source and the electrical load, which are not shown, do not form part of the invention but are used to explain the operating context.

The distribution assembly 100 comprises a distribution device 110, through which the distribution assembly 100 is fixed to the base 14, a main module 200, which is assembled on the distribution device 110, preferably reversibly, and at least one outlet module 300, in this case seven outlet modules, with each outlet module 300 being reversibly assembled on the distribution device 110, in a mounted position of the outlet device 300. To this end, each outlet module 300 comprises mechanical mounting means, which are configured to engage with complementary means of the distribution device 110, so as to hold the outlet module 300 in the mounted position. The mechanical means and the complementary means are not described in this description.

It is thus possible to replace the main module 200, as required, in the event of a malfunction in the main module 200, while retaining the other elements of the distribution assembly 100, the distribution device 110 and the one or more outlet modules 300, which is economical. Similarly, it is possible to replace one or more of the outlet modules 300, as required, for example, in the event of a malfunction, while retaining the other elements, the distribution device 110 and the main module 200, which is economical.

The distribution device 110 assumes an elongated shape, extending along a main axis A110. When the distribution assembly 100 is in a normal operating configuration, the main axis A110 is parallel to the base 14, in other words, orthogonal to the depth axis A14. Preferably, the main axis A110 is horizontal, as illustrated in FIG. 1. A height axis H110 is defined as being an axis that is orthogonal to both the depth axis A14 and the main axis A110. The description is provided with respect to the orientation of the various elements, as shown in the figures, on the understanding that this may be different in reality.

In the example in FIG. 1, the main module 200 is located on the left of the distribution assembly 100, with the outlet modules 300 being located on the right of the main module 200.

When the distribution assembly 100 is fixed to the base 14, a rear portion 112 of the distribution device 110 is oriented opposite the base 14, in other words, it is oriented towards the rear of the distribution assembly 100. The rear direction is thus parallel to the depth axis A14. A front direction is also defined as being the direction opposite the rear direction.

The distribution device 110 thus has a mounting face 114, which is generally oriented towards the front and which is provided for mounting the main module 200 and each outlet module 300.

The rear portion 112 is made of an electrically insulating material, for example, synthetic polymer. The rear portion 112 in this case assumes a generally rectangular shape, the largest dimension of which extends parallel to the main axis A110. The short sides of the rectangle are thus parallel to the height axis H110. The distribution device 110 in this case comprises two flanges 116, which are made of an electrically insulating material. The two flanges 116 are assembled on the short sides of the rear portion 112 so as to form a basket.

The distribution device 110 in this case comprises an insulating wall 118, which is made of an electrically insulating material and which is assembled on the rear portion 112 and on the flanges 116 so as to form a cavity V110, as illustrated in FIG. 3a-3b.

In the illustrated example, the distribution device 110 advantageously comprises a cooling device 400, which is accommodated in the cavity V110 and which is provided in order to discharge some of the heat generated by the main module 200 when the distribution assembly 100 is operating. The cooling device 400 is thus located on a rear side of the insulating wall 118, while on a front side of the insulating wall 118, with the front side being oriented opposite the rear side, the insulating wall 118 has grooves 120 designed to accommodate a plurality of busbars 122, in this case four busbars 122. The busbars 122 together form a power bus 124 of the distribution device 110 and, by extension, of the distribution assembly 100. The distribution device 110 thus is a power distribution device. The rear portion 112 is preferably perforated, in order to promote convection cooling of the cooling device 400. The distribution device 110 thus forms a cage around the cooling device 400.

The busbars 122 extend parallel to each other along the main axis A110 of the distribution assembly 100 and are aligned along the height axis H100. The busbars 122 together define a connection plane P124, which is a plane orthogonal to the depth axis A14, in other words, parallel to the height axis H110 and the main axis A110. The mounting face 114 is generally parallel to the connection plane P124.

The cooling device 400 comprises a contact plate 410, which is designed to capture some of the heat released by the main module 200, a radiator 420, which is designed to dissipate heat into the ambient air, and at least one heat pipe 430, in this case three heat pipes, which connects the contact plate 410 to the radiator 420 and which is configured to transfer some of the heat captured by the contact plate 410 to the radiator 420.

The busbars 122 include at least one phase bar and, optionally, a neutral bar, with the neutral bar being associated with the neutral of the power source, with each phase bar being associated with a respective phase of the power source. In the illustrated example, the power bus 124 comprises four busbars 122, with the power source being a three-phase source with a neutral. The distribution assembly 100 in this case is in a configuration called “3P+N”, or simply 3PN.

In a variant, not shown, the power source is three-phase, with or without a neutral, while the distribution assembly does not include a busbar associated with the neutral. In other words, the distribution assembly includes only three phase bars, each associated with a respective phase of the power source. The distribution assembly is then in a “3P” configuration.

The principles of the invention are transferable irrespective of the number of phases of the power source. According to another variant, not illustrated, the power source is single-phase, i.e., it only includes the neutral and a single phase. The busbars then include a single-phase bar and the neutral bar. The distribution assembly is then in a configuration called P+N, or simply PN. Irrespective of the configurations, there are always several busbars, which include at least one phase bar and optionally a neutral bar.

The main module 200 will now be described, notably with reference to FIGS. 4 and 5. FIG. 5 shows a single-phase circuit, showing the three phases, according to a known convention, as three parallel lines across the circuit.

The main module 200 comprises input terminals 202, which are configured to be connected to the neutral and to each phase of the power source, and output terminals 204, which are configured to be connected to the busbars, with each output terminal being associated with a respective busbar and a respective input terminal. The input terminals 202 are screw terminals in this case. Advantageously, the output terminals 204 are connection clamps, each of which is intended to be reversibly connected to a respective busbar 122, following a connection movement that is oriented towards the rear of the distribution assembly 100. Thus, during the movement to connect the output terminals 204 to the busbars 122, the rear face of the main module 200 comes into abutment against the contact face 412.

For each input terminal 202, the main module comprises a corresponding input line 203, which is connected to the corresponding input terminal 202, and an output line 205, which is connected to the associated output terminal 204.

The main module 200 comprises static switching means 210, which can be switched between an on configuration, in which each input terminal 202 associated with a phase of the power source is electrically connected to the associated output terminal 204, with the main module 200 being in an on configuration, and a cut-off configuration, in which the passage of electrical current between the input terminal 202 and the associated output terminal 204 is prevented, with the main module 200 being in a cut-off configuration.

The static switching means 210 are power switches based on semiconductor components, preferably insulated-gate field-effect transistors, or MOSFETs, and are thus referred to as “static” as opposed to moving-contact switching means. The static cut-off means 210 are connected in series between the input line 203 and the associated output line 205. The static cut-off means 210 are schematically shown in FIGS. 4 and 5.

When operating, the switching means 210 release heat, of the order of several tens of watts. The switching means 210 are advantageously arranged so as to promote the transfer of at least some of the released heat to the cooling device 400.

In particular, the switching means 210 are advantageously arranged against a rear wall 231 of the main module 200, preferably in surface contact against the rear wall 231. The rear wall 231 forms the rear face 230, with the rear face 230 being oriented opposite the switching means 210. The rear wall 231 is thus interposed between the switching means 210 and the contact plate 410 when the main module 200 is mounted on the distribution device 110, so that some of the heat generated by the switching means 210 during operation is transferred to the contact plate 410 through the rear wall.

The rear wall 231 is made of a thermally conductive and electrically insulating material. In the illustrated example, the rear wall 231 is formed from assembling an electrically insulating plate, made of synthetic polymer material, and a copper plate, which imparts rigidity to the assembly while promoting thermal conductivity, with the copper plate forming the rear face 230 and being in abutment against the contact plate 410 when the main module 200 is mounted on the distribution device 110.

The main module 200 comprises main detection means 212, which are configured to measure electrical quantities at the output terminals and to detect an electrical fault based on the measured values. The main detection means 212 in this case are represented by measurement loops, which in this case are arranged on the output lines 205. Preferably, the main detection means 212 include a differential current detection device.

The main module 200 is configured to transition from the on configuration to the cut-off configuration when the main detection means 212 detect a first electrical fault.

The main module 200 comprises a control unit 214, or ECU (Electronic Control Unit), which is configured to control the static cut-off means 210, in other words, to switch the static cut-off means 210 between the on configuration and the cut-off configuration. The control unit 214 is also configured to analyse the values measured by the main detection means 212 and to determine, based on predefined criteria corresponding to a predetermined type of electrical fault, the presence of an electrical fault of the predetermined type. FIG. 5 schematically shows the use of predefined criteria by the presence of a “primary” filter 222, with the primary filter 222 being interposed between the main detection means 212 and the control unit 214. Several types of differential faults exist, which are notably defined in standard IEC 60755:2017. In particular, the types of electrical faults include the fact that the electrical signal is rectified, that the signal includes a high-frequency component, the rating, for example, 30 mA or 300 mA, etc. It is understood that the primary filter 222 defines criteria for detecting electrical faults by the control unit 214 of the main module 200. Preferably, the primary filter 222 defines criteria for detecting a predetermined type of differential fault, with the preferred predetermined fault being selected from among the faults defined in standard IEC 60755:2017.

A cut-off time ΔC is defined as being the time interval between the moment the electrical fault is detected and the transition to the cut-off configuration. The cut-off time ΔC thus includes the time required to analyse the measurements taken by the main detection means, the time required to send an opening order to the static cut-off means 210, and the cut-off time of the static cut-off means 210 once the opening order has been sent. Typically, the cut-off time of the static cut-off means 210 depends on the structure of the static cut-off means and is less than 1 microsecond (μs). Thus, the cut-off time ΔC is basically linked to the operation of the control unit 210. Typically, the cut-off time ΔC is of the order of a microsecond or a few tens of microseconds, for example, ranging between 5 μs and 500 μs.

Preferably, the main module 202 also comprises, for each input terminal 202, a general cut-off device 216, which is a cut-off device with separable contacts, in this case an isolator. The general cut-off device 216 is controlled by the electronic control unit 214 and allows the power source to be electrically disconnected from the distribution unit 100, for example, in the event of a malfunction of the static cut-off means 210. The general cut-off switch 216 is interposed between each input terminal 202 and the static switching means 210.

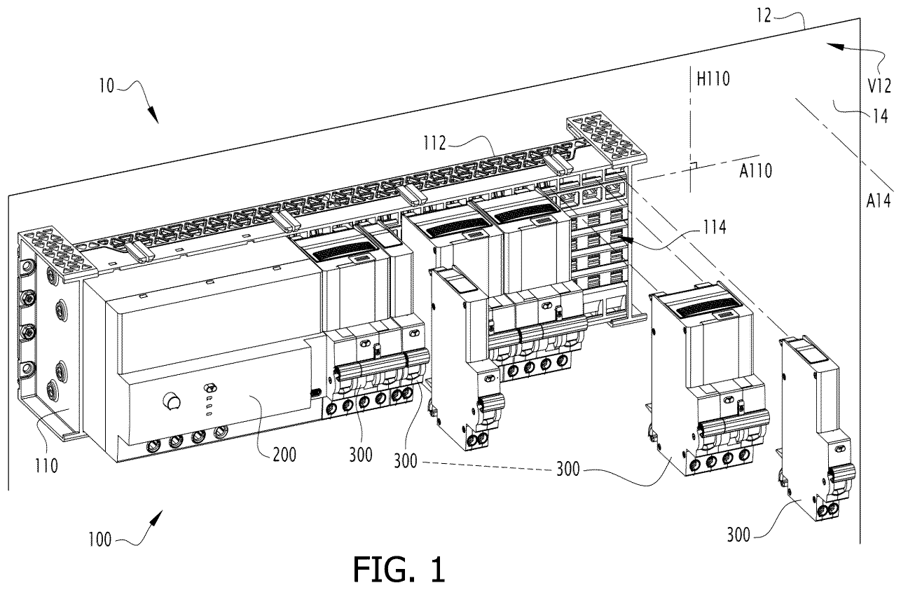

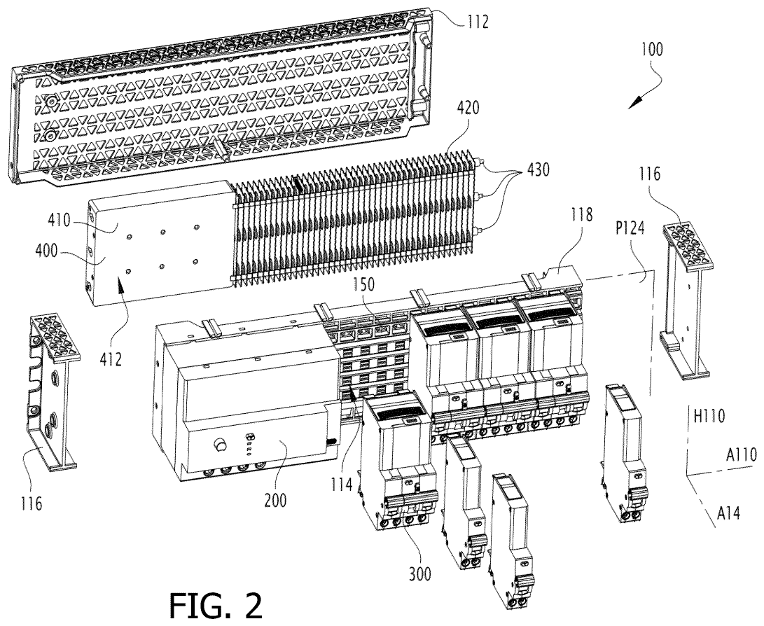

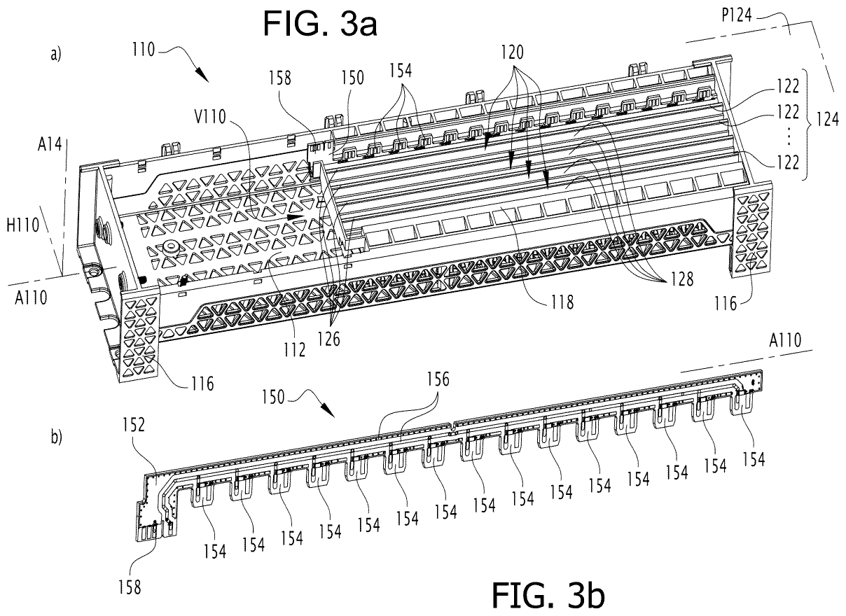

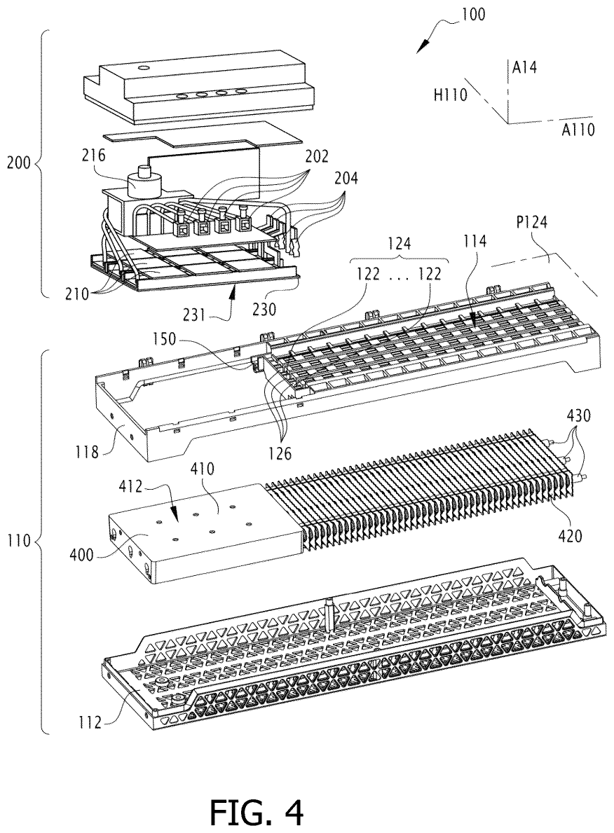

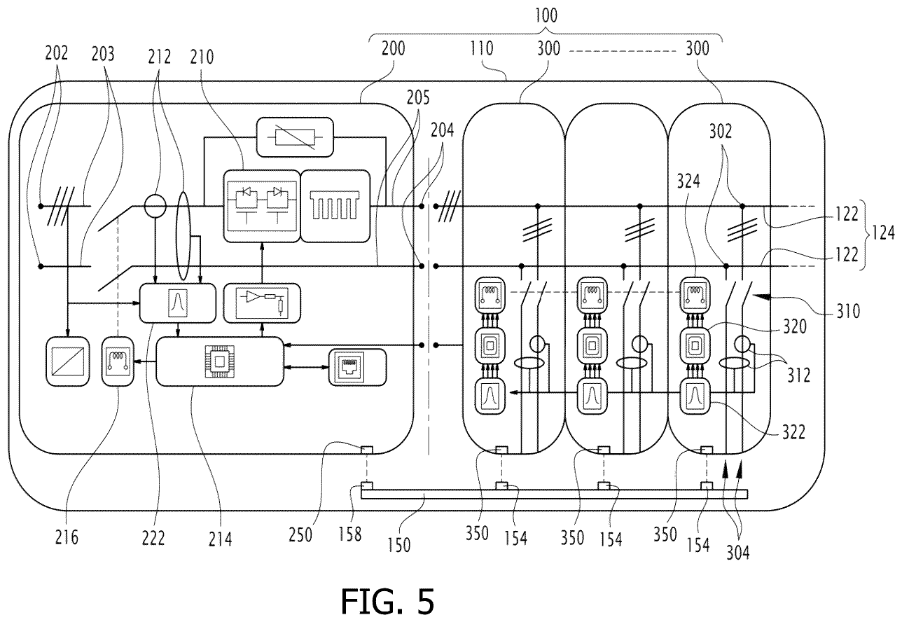

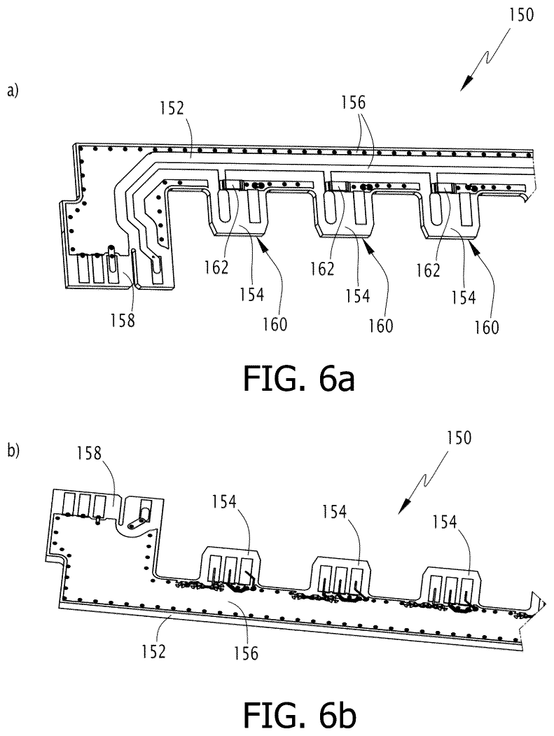

Advantageously, the distribution device 110, and by extension the distribution assembly 100, also comprises a transfer bus 150. The transfer bus 150, which is shown separately in FIG. 3 b) and partially on a larger scale in FIGS. 6a-6b, in this case is provided for the operation of supplying energy to each outlet module 300 in the mounted position, i.e., connected to the busbars 122. The transfer bus 150 in this case therefore is an energy transfer bus, in other words, a power supply bus, which is separate from the power bus 124. According to an illustrative example, the transfer bus 150 operates at a voltage of a few tens of volts, for example, 50 V DC, while the power bus 124 operates at a voltage of 400 V, three-phase AC. The transfer bus 150 in this case is a separate part, which is assembled to the rest of the distribution device 110. The transfer bus 150 is thus easy to manufacture and, if necessary, to replace.

The transfer bus 150 comprises a body 152, which is made of an electrically insulating material and assumes an elongated shape extending along the power bus 124. The transfer bus 150 thus extends along the main axis A110.

The transfer bus 150 defines a plurality of mounting zones 154, which are designed to be connected to each outlet module in the mounted position, with the mounting zones 154 being distributed, preferably evenly, along the main axis A110 and each being associated with a unique position along the main axis A110. The transfer bus 150 comprises a plurality of mounting zones 154, preferably fifteen mounting zones, which are spaced apart from each other at a constant interval. The mounting zones 154 in this case are spaced apart from each other by an 18 mm interval. Of course, other intervals are possible. In a variant, not shown, the mounting zones 154 are spaced apart from each other by an interval of 9 mm. In general, the mounting zones 154 are spaced apart at regular intervals, preferably an integer multiple of 9 mm.

The transfer bus 150 comprises at least two transfer lines 156, which extend along the body 152 and which are configured to be electrically connected to each outlet module 300 in the mounted position. The transfer lines 156 are power supply lines in this case.

The transfer bus 150 also comprises a connection zone 158, which is intended for connecting the main module 200 in the mounted position on the distribution device 110. For example, the main module 200 comprises an additional terminal block 250, which is configured to engage with the connection zone 158, so that the main module is electrically connected to the transfer lines 156. In the preferred illustrated example, the main module 200 draws the electrical energy required to power the transfer bus 150 from the neutral and phases of the power source, between the static cut-off means 210 and the general cut-off device 216, with the electrical energy thus supplied being available to the outlet modules 300 for the operation thereof.

The transfer bus 150 in this case is implemented by a printed circuit board, with the transfer lines 156 being conductive tracks provided on the surface of the board, while the mounting zones 154 and the connection zone 158 are tabs provided in the substrate of the board.

Each outlet module 300 in the mounted position occupies one or more juxtaposed mounting zones 154, preventing the other outlet modules 300 from being mounted on the one or more mounting zones 154 thus occupied. Preferably, an outlet module 300 intended for connecting a single-phase electrical load occupies a single mounting zone 154, while an outlet module 300 intended for connecting a three-phase electrical load occupies three juxtaposed mounting zones 154. Thus, the position of each outlet module 300 along the distribution device 110 is unambiguously defined by the one or more mounting zones 154 occupied by the considered outlet module 300. Preferably, when an outlet module 300 occupies a plurality of juxtaposed mounting zones 154, the position of this outlet module 300 along the distribution device 110 is defined by the position of the mounting zones 154 thus occupied that is closest to the connection zone 158.

The outlet modules 300 will now be described.

Each outlet module 300 thus comprises an inlet terminal block, which can be reversibly connected to the busbars 122 and which comprises at least two inlet terminals 302, with each inlet terminal 302 being configured to be electrically connected to a respective busbar 122. For each outlet module 300, the inlet terminals 302 include a neutral inlet terminal, which is configured to be electrically connected to the neutral bar, and between one and three other inlet terminals, each of which is configured to be connected to a respective phase bar. Each outlet module 300 is configured to be reversibly mounted on the power bus 114, such that each inlet terminal 302 is electrically connected to the corresponding busbar 122.

Each outlet module 300 also comprises an outlet terminal block, which is configured to be connected to an electrical load and which comprises outlet terminals 304, with each outlet terminal 304 being respectively associated with a respective inlet terminal 302. The outlet terminals 304 are schematically shown in FIG. 5.

In the illustrated example, the outlet modules 300 have different widths, with the width being measured along the main axis A110. Thus, the outlet modules 300 are divided into two sub-groups, which correspond to two different widths, with thin outlet modules 300 and wide outlet modules 300, which are substantially three times wider than the thin outlet modules 300. Of course, other widths of outlet modules 300 can be contemplated. The width of the outlet modules 300 preferably is a multiple of the interval between each mounting zone 154 of the transfer bus 150, that is, 18 mm in this case. In a variant, not shown, the outlet modules 300 have a width equal to a multiple of 9 mm.

The thinnest outlet modules 300 are configured to be connected to two busbars 122, including a neutral bar and a phase bar, while the wide outlet modules 300 are configured to be connected to four busbars 122. The principles of the invention are applicable irrespective of the number of phases to which each of the outlet modules 300 is connected.

Preferably, the distribution device 110 is designed to accommodate five outlet modules 300, each of which comprises four inlet terminals, in other words, five wide outlet modules 300. According to one example, not illustrated, the distribution assembly 100 comprises five outlet modules 300, each comprising four inlet terminals 302. As a corollary, the distribution device 110 is also designed to accommodate fifteen thin outlet modules 300, each comprising two inlet terminals 302.

The busbars 122 each comprise:
a power supply portion 126, which is configured to be connected to an associated output terminal 204 of the main module 200 in a mounted configuration of the main module; and
a connection portion 128, which extends from the same side of the power supply portion 126. The connection portions 128 are geometrically located on a front side of the connection plane P124 and together define a connection zone of the power bus 124.

FIG. 4 only shows the power supply portions 126 of the busbars 122, with the connection portions 128 being hidden. The connection zone is configured to accommodate at least one outlet module 300, such that the outlet module is connected to the power bus 129. The outlet module 300 is then able to be connected to an electrical load, so as to supply the electrical load with electrical power.

Each outlet module 300 comprises electromechanical switching means 310, which are interposed between each inlet terminal 302 and the corresponding outlet terminal 304. The electromechanical switching means 310 comprise separable contacts, which can be moved between a closed position, in which each inlet terminal 302 is electrically connected to the associated outlet terminal 304, with the relevant outlet module 300 being in a closed configuration, and an open position, in which the passage of an electric current between the inlet terminal 302 and the associated outlet terminal 304 is prevented, with the relevant outlet module 300 being in an open configuration.

Each outlet module 300 comprises secondary detection means 312, which are configured to measure electrical quantities across the corresponding outlet terminals and to detect at least one electrical fault of a predetermined type, i.e., corresponding to predetermined detection criteria. The secondary detection means 312 in this case are represented by measurement loops, which in this case are arranged on the wires connecting the inlet terminals 302 to the outlet terminals 304.

Preferably, the secondary detection means 312 include a differential current detection device. Preferably, the outlet module 300 comprises a microcontroller 320, which is configured to evaluate the differential current measurement using a “secondary” filter 322, with the secondary filter 322 being previously stored in a memory of the microcontroller 320 of the outlet module 300 and being adapted to detect a differential fault.

The microcontroller 320 is powered via the transfer bus 150. To this end, each outlet module 300 comprises a transfer terminal block 350, which comprises transfer terminals, not shown, with the transfer terminal block 350 being configured to be connected to the transfer bus 150 so that each transfer terminal is electrically connected to a respective transfer line 156. The transfer terminal block 350 therefore in this case is a power supply terminal block. The transfer terminals are different from the inlet terminals 302 or the outlet terminals 304. Each outlet module 300 in the mounted position on the distribution device 110 is thus jointly connected to the power bus 124, via the inlet terminals 302, and to the transfer bus 150, via the transfer terminals. The transfer terminal block 350 is schematically shown in FIG. 5.

It is understood that the secondary filter 322 defines the criteria for detecting electrical faults detected by the microcontroller 320 of the outlet module 300. Preferably, the secondary filter 322 defines detection criteria for a predetermined type of differential fault, which is selected from among the faults defined in standard IEC 60755:2017.

Each microcontroller 320 is supplied with operating electrical energy via the transfer bus 150, irrespective of the configuration, namely, activated or tripped, of the switching mechanism, in this case the electromechanical cut-off means 310, of the outlet module 300.

Each outlet module 300 in this case comprises an actuator 324, which is configured to move the electromechanical cut-off means 310 to the open position when the actuator receives a tripping signal, with the microcontroller 320 being configured to send the tripping signal to the actuator 324 upon the detection of a differential fault.

Each outlet module 300 is configured to transition from the closed configuration to the open configuration when the secondary detection means 312 detect an electrical fault.

An opening time ΔO is defined as being a time interval between the moment the electrical fault is detected and when the separable contacts of the electromechanical cut-off means 310 start to move from the closed position to the open position. In the illustrated example, the opening time includes the time for processing the measurements by the microcontroller 320, as well as the time for the microcontroller 320 to send the cut-off order to the actuator 324. Typically, the opening time ΔO is of the order of milliseconds, for example, from 1 ms to 9 ms.

In a minimal configuration of the distribution assembly 100, the distribution assembly comprises the distribution device 110, on which the main module 200 and a single outlet module 300 are mounted. It is assumed that the distribution assembly 100 is connected to a power source via the input terminals 204, while an electrical load is connected to the output terminals 304.

In a normal operating configuration, the main module 200 is initially in the on configuration, while the outlet module 300 is initially in the closed configuration. Thus, the inlet terminals 304 are each electrically connected to a respective output terminal 204 via the associated busbar 122. When an electrical fault occurs, for example, due to an electrical load failure, the electrical fault can be detected both by the main module 200, by means of the main detection means 212, and by the outlet module 300, by means of the secondary detection means 312.

In other words, the electrical fault detection criteria used by the main module 200 are identical to the electrical fault detection criteria used by the considered outlet module 300. In the illustrated example, the detection criteria are defined by the detection filters, in this case the primary filter 222 for the main module 200 and the secondary filter 322 for the outlet module 300. It is assumed that they functionally define the same detection criteria, in other words, that the primary filter 222 and the secondary filter 322 are functionally identical to each other, so that the main module 200 and the outlet module 300 are configured to detect electrical faults according to the same criteria.

The distribution assembly 100 is configured so that, when an electrical fault corresponding to the criteria of the primary filter 222 and the secondary filter 322 occurs:
the outlet module 300 detects the electrical fault by means of the secondary detection means 312, then the microcontroller 320 of the outlet module commands the electromechanical cut-off means 310 to transition to the open position;
while the main module 200 detects the same electrical fault by means of the main detection means 212, then the control unit 214 of the main module 200 commands the switching means 210 to transition to the cut-off configuration.

Given the proximity of the main module 300 to the outlet module 300, the detection of the same electrical fault by the main module 200 and by the outlet module 300 is considered to be simultaneous.

The distribution assembly 100 is configured so that the main module 200 transitions to the cut-off configuration before the first module transitions from the closed configuration to the open configuration. In other words, the cut-off time ΔC is less than the opening time ΔO, so that when the separable contacts of the electromechanical cut-off means 310 begin to move from the closed position to the open position, then no current flows through the power bus 114. The separable contacts of the electromechanical switching means 310 open without generating an electric arc, which reduces wear on the separable contacts and contributes to the durability of the outlet modules 300.

Once the outlet module 300 is in the open configuration, the main module 200 is configured to transition from the cut-off configuration to the on configuration after a predetermined waiting time ΔW, with the waiting time ΔW being greater than the opening time.

The case whereby the distribution assembly comprises two or more outlet modules 300 will now be considered, with the two outlet modules 300 including a first module and a second module, which are jointly connected to the busbars 122. In other words, the two outlet modules 300 are mounted on the same distribution device 110. During normal operation of the distribution assembly 100, the main module 200 is initially in the on configuration, while the first module 300 and the second module 300 are each initially in the closed configuration. It is assumed that the first module 300 and the second module 300 are each connected to a respective electrical load.

When an electrical fault occurs across the output terminals 300 of the first module 300, for example, as a result of a failure of the electrical load connected to the first module 300, the first outlet module 300 detects this electrical fault by means of the secondary detection means 312 of the first module 300 and, simultaneously, the main module 200 also detects this electrical fault by means of the main detection means 212. As before, the main module 200 transitions to the cut-off configuration before the first module 300 transitions from the closed configuration to the open configuration, while the second module 300 remains in the closed configuration.

Then, the main module 200 transitions from the cut-off configuration to the on configuration at the end of the waiting time ΔW, with the second module 300 remaining in the closed configuration. The waiting time ΔW is short enough for the interruption in power experienced by the electrical load associated with the second module 300 to have no negative impact. In practice, the waiting time ΔW is less than 20 ms, preferably less than 15 ms, and even more preferably less than 10 ms.

According to another aspect of the invention, when each outlet module 300 is mounted on the distribution device 110, each outlet module 300 in the mounted position is able to identify its position along the transfer bus 150 and, by extension, its position along the distribution device 110. To this end, the transfer bus 150 comprises, for each mounting zone 154, a position identification circuit 160. An embodiment of the identification circuit 160 is shown in FIG. 6 a). Each identification circuit 160 is configured to transmit information to the outlet module 300 in the mounted configuration relating to the position, along the main axis, of the mounting zone 154 on which the outlet module 300 is mounted.

Each outlet module 300 advantageously comprises positioning terminals, which are configured to be electrically connected to the identification circuit 160 associated with the considered mounting zone 154. The positioning terminals, which are not shown, in this case form part of the transfer terminal block 150. In other words, the transfer terminal block 150 is advantageously configured to be jointly connected to the transfer lines 156 and to the identification circuit 160.

According to a preferred embodiment, the identification circuit 160 comprises an identification component 162, which is selected from among a list including a resistor, an inductor, a Zener diode, a voltage reference or a capacitor, such that when the outlet module 300 is in the mounted configuration and is supplied with electrical energy in order to operate, the outlet module 300 applies a first electrical quantity across the terminals of the identification component 162 and measures a second electrical quantity characteristic of the identification component 162, with the second characteristic electrical quantity being unambiguously linked, preferably bijectively, to the unique position of the considered mounting zone. Thus, the outlet module 300 identifies its own position, for example, by measuring the second characteristic electrical quantity and comparing the measured value with a predetermined correspondence table, with each interval being unambiguously, preferably bijectively, associated with a position along the distribution device 110. The correspondence table unambiguously, preferably bijectively, links intervals of the second characteristic electrical quantity to a unique position along the transfer bus 150. Preferably, the correspondence table is previously stored in a memory of the microcontroller 320.

Preferably, the identification circuit 160 comprises only a single identification component 162 selected from among a resistor, an inductor, a Zener diode, a voltage reference or a capacitor. As an alternative, not illustrated, several identification components 162 are combined within the identification circuit 160.

The identification component 162 is preferably an electrical resistor, as in the illustrated example. In the illustrated example, the outlet module 300 injects a current with a predetermined value into the identification component 162 and measures an electrical voltage across the terminals of the identification component. In a variant, not illustrated, when the transfer bus 150 comprises power lines, a voltage is directly measured across the terminals of the identification component 162, without the outlet module injecting current into the identification component.

The identification circuit 160 is thus particularly simple to implement and is reliable. Each mounting zone 154 is associated with a resistor with a value, expressed in ohms, that is unique and different enough from the other resistors associated with the other mounting zones 154, so that the voltage measured across the terminals of each identification component 162 is different enough from the other measured voltages. Preferably, the identification components 162, in this case resistors, each have their own resistance value, which is expressed in ohms and which gradually changes when moving along the main axis.

In the illustrated non-limiting example, each outlet module 300 is configured to apply a voltage of 3 V across the terminals of the identification circuit 160. R1 denotes an internal resistor of the outlet module 300, and R2 denotes the resistance value of the identification component 162. The transfer bus 150 comprises 15 mounting zones 154. The 3 V is distributed over the 15 intervals, preferably evenly distributed: there are therefore 15 intervals and 16 “pillars” separating the intervals, representing an interval of 3 V /16=0.1875 V. For each position n between 1 and 15, the corresponding R2 value is computed using the formula 3 V=n×0.1875×(R1+R2)/R2. Of course, other methods are possible, notably depending on the nature of the identification components 162 used, etc.

In the illustrated example, each outlet module 300 is supplied with electrical energy, in order to operate, via the transfer lines 156 supported by the transfer bus 150. As an alternative, not shown, each outlet module 300 comprises an electrical energy storage device, for example, a battery or, advantageously, a capacitor, which does not need to be replaced during the lifetime of the outlet module 300.

Irrespective of the type of power supply to the outlet modules 300, each outlet module 300 knows its position as soon as it is mounted on the distribution device 110.

The distribution assembly 100 of the invention allows a method to be implemented for locating each outlet module 300 when mounting this outlet module. Initially, a copy of the distribution device 110 as defined above and a copy of an outlet module 300 as defined above are provided.

Then, the outlet module 300 is mounted on the distribution device 110 in the vicinity of one of the free mounting zones 154, so that the transfer terminal block 350 is electrically connected to the transfer bus 150, supplying electrical energy to the microcontroller 320 of the outlet module 300, while the positioning contacts are electrically connected to the identification circuit 160.

Then, using the powered microcontroller 320, a first electrical quantity is applied across the terminals of the identification component 162 via the positioning contacts, and a second electrical quantity characteristic of the identification component 162 is measured.

Then, the unique position is deduced, along the transfer bus, of the mounting zone 154 on which the outlet module 300 is mounted by means of a correspondence table, previously stored in a memory of the microcontroller 320, with the correspondence table unambiguously, preferably bijectively, linking intervals of the second characteristic electrical quantity to a unique position along the transfer bus 150.

Advantageously, each outlet module 300 then transmits information related to the unique position of the considered outlet module 300 to the main module 200 via the transfer bus 150. According to a preferred example, the transfer bus 150 is configured to provide a data transmission bus, called CAN (Controller Area Network) bus, as defined in standard ISO 11898-2:2024, for communication between the outlet modules 300 and the main module 200. When an outlet module 300 is mounted on the distribution device 110 for the first time, once the outlet module 300 has determined its unique position by means of the microcontroller 320, the outlet module also determines a CAN number and transmits this number to the main module 200 via the CAN bus. The CAN number is determined, for example, by means of a table, previously stored in the memory of the microcontroller 320, connecting the unique position and the CAN number. The main module 200 then uses this CAN address to send specific commands to the corresponding outlet module 300, for example, opening orders, closing orders, configuration orders, etc. The transfer bus 150 is also advantageously used to transfer diagnostic information from the outlet module 300 to the main module 200, for example, information relating to the status of the outlet module 300, the causes of any triggers, etc.

The aforementioned embodiments and variants can be combined together in order to generate new embodiments of the invention.

1. An electrical power distribution device configured to distribute electrical energy from a power source to at least one electrical load, the distribution device comprising:
a power bus, which comprises a plurality of busbars:
which include at least one phase bar and optionally a neutral bar, with the neutral bar being associated with the neutral of the power source, with each phase bar being respectively associated with a phase of the power source;
which extend parallel to each other along a main axis of the distribution device;
wherein:
the power bus is configured to accommodate at least two outlet modules, with each outlet module comprising:
an inlet terminal block, which can be reversibly connected to the busbars and which comprises inlet terminals, with each inlet terminal being configured to be electrically connected to a respective busbar; and
an outlet terminal block, which is configured to be connected to an electrical load and which comprises outlet terminals, with each outlet terminal being respectively associated with a respective inlet terminal;
the distribution device also comprises a transfer bus, which comprises:
a body, which is made of an electrically insulating material, which assumes an elongated shape extending along the power bus, and which defines a plurality of mounting zones for each outlet module, with the mounting zones being distributed along the main axis and each being associated with a unique position along the main axis;
at least two transfer lines, which extend along the body and which are configured to be electrically connected to each outlet module when the outlet module is connected to the power bus in the vicinity of one of the mounting zones, with the outlet module being in a mounted position on the distribution device;
the transfer bus comprises, for each mounting zone, a position identification circuit, which is configured to send the outlet module in the mounted configuration information relating to the position, along the main axis, of the mounting zone on which the outlet module is mounted.

2. The distribution device according to claim 1, wherein:
for each mounting zone, the identification circuit comprises an identification component, which is selected from among a resistor, an inductor, a Zener diode, a voltage reference or a capacitor, such that when the outlet module is in the mounted configuration and is supplied with electrical energy, the outlet module applies a first electrical quantity across the terminals of the identification component and measures a second electrical quantity characteristic of the identification component, with the second characteristic electrical quantity being unambiguously linked to the unique position of the considered mounting zone.

3. The distribution device according to claim 2, wherein:
for each mounting zone the identification component is a resistor.

4. The distribution device according to claim 3, wherein:
the resistors each have their own resistance value, which is expressed in ohms and which gradually changes when moving along the main axis.

5. The distribution device according to Claim 1, wherein:
the mounting zones are evenly distributed along the main axis.

6. The distribution device according to claim 5, wherein:
the transfer bus comprises a plurality of mounting zones which are spaced apart from each other at regular intervals.

7. An outlet module, configured to be jointly connected to a distribution device according to Claim 1, the outlet terminal block comprising:
an inlet terminal block, which can be reversibly connected to the power bus and which comprises inlet terminals, with each inlet terminal being configured to be electrically connected to a respective busbar; and
an outlet terminal block, which is configured to be connected to an electrical load and which comprises outlet terminals, with each outlet terminal being associated with a respective inlet terminal;
a transfer terminal block, which comprises:
transfer terminals, which are configured to be connected to the transfer bus so as to be electrically connected to the transfer lines; and
positioning terminals, which are configured to be electrically connected to the identification circuit associated with the considered mounting zone.

8. The outlet module according to Claim 7, wherein:
the outlet module also comprises a microcontroller, which is configured so that, when the outlet module is in the configuration whereby it is mounted on one of the mounting zones and is supplied with electrical energy, the outlet module applies, by means of the microcontroller, a first electrical quantity across the terminals of the identification component and measures a second electrical quantity characteristic of the identification component, with the second characteristic electrical quantity being unambiguously related to the unique position of the considered mounting zone.

9. The distribution assembly according to Claim 13, further comprising:
a main module, which is configured to be mounted on the distribution device and which comprises:
input terminals, with each input terminal being configured to be connected to a respective phase and optionally to the neutral of the power source;
output terminals, which are configured to be connected to the busbars, with each output terminal being associated with a respective busbar and a respective input terminal;
wherein:
the transfer bus also comprises a connection zone, which is intended to be connected to an additional terminal block of the main module in the mounted position, so that the
main module is electrically connected to the transfer lines;
the main module is configured to receive, via the transfer lines and for each outlet module in the mounted position, information relating to the position, along the main axis, of the mounting zone on which the considered outlet module is mounted;
the outlet module and/or the main module are each in a configuration whereby they are mounted on the distribution device.

10. (canceled)

11. (canceled)

12. The distribution device according to claim 6, wherein the transfer bus comprises fifteen mounting zones, which are spaced apart from each other at multiples of 9 mm.

13. A distribution assembly comprising:
an electrical power distribution device configured to distribute electrical energy from a power source to at least one electrical load; and
an outlet module configured to be jointly connected to the distribution device,
wherein:
the distribution device comprises:
a power bus, which comprises a plurality of busbars:
which include at least one phase bar and optionally a neutral bar, with the neutral bar being associated with the neutral of the power source, with each phase bar being respectively associated with a phase of the power source;
which extend parallel to each other along a main axis of the distribution device;
wherein:
the power bus is configured to accommodate at least two outlet modules, with each outlet module comprising:
an inlet terminal block, which can be reversibly connected to the busbars and which comprises inlet terminals, with each inlet terminal being configured to be electrically connected to a respective busbar; and
an outlet terminal block, which is configured to be connected to an electrical load and which comprises outlet terminals, with each outlet terminal being respectively associated with a respective inlet terminal;
the distribution device also comprises a transfer bus, which comprises:
a body, which is made of an electrically insulating material, which assumes an elongated shape extending along the power bus, and which defines a plurality of mounting zones for each outlet module, with the mounting zones being distributed along the main axis and each being associated with a unique position along the main axis;
at least two transfer lines, which extend along the body and which are configured to be electrically connected to each outlet module when the outlet module is connected to the power bus in the vicinity of one of the mounting zones, with the outlet module being in a mounted position on the distribution device;
the transfer bus comprises, for each mounting zone, a position identification circuit), which is configured to send the outlet module in the mounted configuration information relating to the position, along the main axis, of the mounting zone on which the outlet module is mounted,
and wherein:
the outlet module comprises:
an inlet terminal block, which can be reversibly connected to the power bus and which comprises inlet terminals, with each inlet terminal being configured to be electrically connected to a respective busbar; and
an outlet terminal block, which is configured to be connected to an electrical load and which comprises outlet terminals, with each outlet terminal being associated with a respective inlet terminal;
a transfer terminal block, which comprises:
transfer terminals, which are configured to be connected to the transfer bus so as to be electrically connected to the transfer lines; and
positioning terminals, which are configured to be electrically connected to the identification circuit associated with the considered mounting zone.

14. The distribution assembly according to claim 13, wherein:
for each mounting zone, the identification circuit comprises an identification component, which is selected from among a resistor, an inductor, a Zener diode, a voltage reference or a capacitor, such that when the outlet module is in the mounted configuration and is supplied with electrical energy, the outlet module applies a first electrical quantity across the terminals of the identification component and measures a second electrical quantity characteristic of the identification component, with the second characteristic electrical quantity being unambiguously linked to the unique position of the considered mounting zone.

15. The distribution assembly according to claim 14, wherein:
for each mounting zone, the identification component is a resistor.

16. The distribution assembly according to claim 15, wherein:
the resistors each have their own resistance value, which is expressed in ohms and which gradually changes when moving along the main axis.

17. The distribution assembly according to claim 13, wherein:
the mounting zones are evenly distributed along the main axis.

18. The distribution assembly according to claim 17, wherein:
the transfer bus comprises a plurality of mounting zones, which are spaced apart from each other at regular intervals.

19. The distribution assembly according to claim 18, wherein the transfer bus comprises fifteen mounting zones, which are spaced apart from each other at multiples of 9 mm.
